(19) United States
(12) Patent Application Publication
(10) Pub. No.: US 2018/0157412 A1
(43) Pub. Date: Jun. 7, 2018

(54) METHOD FOR INPUTTING SPECIAL SYMBOL, AND INPUT METHOD SYSTEM

(71) Applicant: Lianhui ZHOU, (US)

(72) Inventor: Lianhui ZHOU, Zhangjiagang, Jiangsu (CN)

(21) Appl. No.: 15/735,166

(22) PCT Filed: Jun. 15, 2015
(86) PCT No.: PCT/CN2015/000413

§ 371 Date: Dec. 9, 2017

(30) Foreign Application Priority Data
Jun. 11, 2015 (CN) 201510319517.1

(51) Int. Cl. G06F 3/0489; G06F 3/023

(52) U.S. Cl. CPC G06F 3/04895; G06F 3/0236

(57) ABSTRACT

Provided is the Method for inputting Special Symbol,and input Method System, comprise: the user activate the IME program pressing an indexical key or combinational keys including such indexical key, the IME program retrieves from its dictionary data, and the IME interface displays these specific symbols which are designated to indexical key or combinational keys including such indexical key; the geometrical forms of said indexical key is identical to that of designated specific symbol or a constituent part of it; the present invention is capable of entering myriad specific symbols with speed and specificity.

### FIELD OF INVENTION

The present invention relates to specific symbols input method editor/IME and input method editor System, which is pertain to IME of computer technologies.

### BACKGROUND ART

When computer users use computers to edit text document, they of need to enter some specific symbols such as mathematical, unit and other ones; only few symbols are be input into directly via the keyboard due to its keycaps encumbrance; they either frequently interpolate those specific symbols being incapably typed into directly from the symbols set appendix to office software (e.g. Word of Window) or select target symbol by activating virtual keyboard; both methods are needed to choose from numerous optional symbols for one by one look-up; if encountering with an unrecognized ideograph and its classification, the overall set of symbols are thoroughly searched for pinpointing.

Taking the Chinese book title mark “<”, for instance, if a user fails to know how to read it, he/she will impossibly input according to its Pinyin pronunciation. For those non-Chinese users, under the condition of English, Germany or French IME, it is unreasonable to install a Chinese IME software merely for inputting a few of specific symbols.

Ultimately, in such condition of non Chinese IME, specific symbols are only able to be typed into the documents such as “Word” or “Excel ”; if inputting them in a text or webpage, generally, a document in word formatted required to open, for copying and pasting them upon the target text or webpage by pull-down menu for inserting-specific symbol.

In nutshell, all of these operating methods abovementioned are complicated, clumsy and confined to narrowness, therefore a method of more simplistic, efficient, all-purposed and cross-languages are needed for those computer users who often use them.

### SUMMARY OF INVENTION

The present invention provides Method for Inputting Special Symbol and Input Method System to overcome difficulty in inputting them by prior arts, said method comprise:
the user activate the IME program, pressing an indexical key or combinational keys including such indexical key, the IME program retrieves from its dictionary data, and the IME interface displays these specific symbols which are designating to indexical key or combinational keys including such indexical key; the geometrical forms of said indexical key is identical to that of designated specific symbol or a constituent part of it, as a numeric key is stroked, to which a desired specific symbol is assigned in the interface is inputted; furthermore, said key in combination including indexical one is “ALT+indexical keys”.

one IME system for realizing aforesaid specific symbols is disclosed with the present invention, comprising an IME program, an operational interface, a dictionary data, IME program, said dictionary data comprise specific symbols, of indexical key symbols or combinational key symbols including them, which are assigned to those symbol in comply with the condition below:

the geometrical forms of said indexical key is identical to that of designated specific symbol or a constituent part of it; said indexical key is defined as symbolic key of United States keyboard.

Further, as received the users commands, said IME program retrieves from its dictionary data, and the interface of the IME displays these specific symbols designated by the input directives for user option; the IME program could be achieved by computer program such as C++ or Visual Basic; furthermore, said keys in combination including indexical one are “ALT+indexical keys”; further said IME operational interface comprise multi option to specific symbols, which is used for user directly press indexical key for displaying and choosing the desired specific symbols under such condition as combinational key symbols including indexical key symbols assigned to these specific symbols.

By utilization of a rule that indexical key is identical to or geometrical part of these configuration of specific symbols, the invention render beneficial effects such as that users need neither their nomenclatures nor classification, as long as finding a key of an indexical symbol congruent with or constituent parts of these specific symbols, which could be inputted by pressing an indexical key or combinational keys including such indexical key; and one indexical key may designated to multi keys of specific symbols.

Therefore, the present invention is capable of entering myriad specific symbols with speed and specificity.

### BRIEF DESCRIPTION OF ACCOMPANYING DRAWINGS

FIG. 1 shows UI schematic diagraph for embodiment 1

FIG. 2 shows a schematic diagraph of the UI for embodiment 2

FIG. 3 shows a schematic diagraph of the UI for embodiment 3

FIG. 4 shows a schematic diagraph of the UI for embodiment 4

FIG. 5 shows a flow chart of the present invention

### EMBODIMENTS OF INVENTION

The present invention is now described in detail with reference to the following exemplary embodiments.

### EXAMPLE 1

As said Method for Inputting Special Symbol and Input Method System program at computer terminal be activated by a user, simultaneously pressing modifier key “Alt” and indexical key “−” (corresponding to minus symbol on a standard keyboard), the IME program retrieves from dictionary data, and read out the specific symbols on the interface, to which indexical key “−” is designated as illustrated in FIG. 1, hereinto the configuration of 3^{rd} option i.e. specific symbol “−” is congruent with the indexical key “−”, the reminder arc of constituent part “−”; if a user intends to input division sign “+”, he/she will get its display on the screen just by pressing numeric key “4”.

In such circumstance, indexical keys are directly designated to specific symbols; and one indexical key could be either designated to a numerous of specific symbols or one specific symbol could be represented by different indexical keys, for instance, “‰” symbol could be displayed by either the indexical key “%” or “/”; it is unnecessary for users to memorize the rule of inputting specific symbols.

### EXAMPLE 2

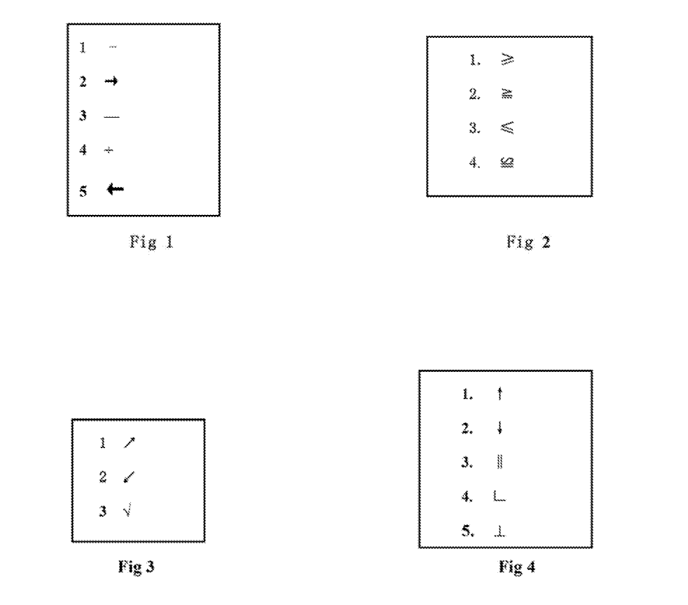

As said Method For Inputting Special Symbol, And Input Method System at computer terminal be activated by a user, simultaneously pressing modifier key “Alt” and indexical key “=” (corresponding to equal symbol on a standard keyboard), the IME programme retrieves from dictionary data, and read out the specific symbols on the interface, to which indexical key “=” is designated as illustrated in FIG. 2, and all specific symbols being displayed include the symbol “=”. If user intends to input“≅”, he/she will get its display on the screen just by pressing numeric key“4”.

The IME program could be realized via computer program such as C++ or Visual Basic. As received the user's directives, said IME program retrieves from its dictionary data, and the interface of the IME displays these specific symbols designated by the input directives for user option.

In such embodiment as typing the keys of a keyboard, there will he no options for the specific symbols unless “Alt+indexical key” is pressed, which will not hamper usual inputting, what is more, “Alt” key is seldom used in combination with other keys, almost causing no clash with other inputting functions. Excluding the condition of “Alt” key as shortcut one in Word or Excel program, for instance, “Alt+=”is shortcut key for “inserting formula” in Word, and shortcut key for “sum” in Excel, moreover, these functions can be materialized by manoeuvring mouse and clicking pull-down menu; in addition to that, “Alt” key is of rare occurrence, whereas inputting specific symbols more frequently occurs to computer users.

### EXAMPLE 3

In this embodiment under the condition of combinational keys including a indexical key designated to specific symbols, the operational interface comprise the option for specific symbols, which is used for users pressing a indexical key directly, the IME program automatically retrieves from dictionary data, and read out the specific symbols designated to combinational key symbols including indexical key for users choosing.

After choosing the option for the specific symbol, the user presses indexical key “/” (keyboard), the IME program retrieves from dictionary data, and read out the specific symbols on the interface, to which indexical key “/” is designated as illustrated in FIG. 3, the user is able to input desired symbols according to his/her requirements, in this way, the looking up specific symbols is undertaken by the IME programme, what to be done by the user is just inputting indexical keys and in no case of pressing indexical keys clashing with normal inputting as usual.

### EXAMPLE 4

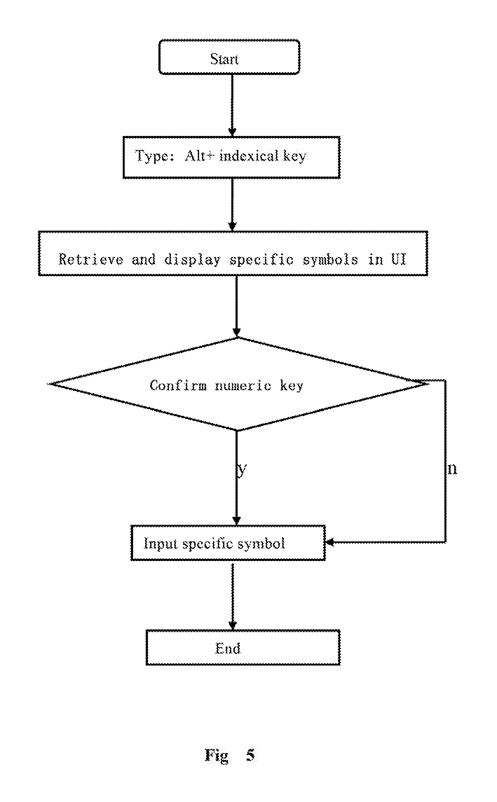

For the symbols of “\” and “|”, both of optional indexical keys using same key “ [symbol] ”, of which, “|” is upper shift key, in this circumstance, “Alt+ [symbol] ” is designated to the specific symbols corresponding to the key “\”; for the specific symbols corresponding to the key “|”, the users are able to fulfill such job by double clicking “ [symbol] ”, and the IME program retrieves from dictionary data, and read out the specific symbols on the interface, to which indexical key “|” is designated as illustrated in FIG. 4 for the user selecting accordingly.

In addition to aforesaid embodiments, any other specific symbols could be inputted by this invention, more details are illustrated below:

1) “Alt+ double clicking “ [symbol] ” for optional entering: “˜ [symbol] ∞ ∝”:

2) “Alt+%” for optional entering: ‰ □:

3) “Alt+^{∧}” for optional entering: [symbol] Δ:

4) “Alt +*” for optional entering: ×:

5) “Alt +<” for optional entering: [symbol] « ∠≤≤ ≯:

6) “Alt+>” for optional entering: [symbol] » ≥ ≥ ≯:

7) “Alt+·” for optional entering: · . . . ∴ ∵.

The foregoing description of the preferred embodiments of the present invention has been provided for the purposes of illustration and description. Obviously, many modification and variations will be apparent to personals skilled in the art, which, by using the principle of the present invention described, should also be fallen into the protective scope of the present invention.

1. An IME for inputting specific symbols, wherein said IME comprise:
the user activates the IME program pressing an indexical key or combinational keys including such indexical key, the IME program retrieves from its dictionary data, and the interface of the IME displays these specific symbols which is designating to indexical key or combinational keys including such indexical key; the geometrical forms of said indexical key is identical to that of designated specific symbol or a constituent part of it, as a numeric key is stroked, to which a desired specific symbol is assigned in the interface is inputted and displayed.

2. The IME of claim 1, wherein said combinational keys including an indexical key is “Alt+the indexical key”.

3. One IME program system for realizing claim 1 or 2, comprising an operational interface, a dictionary data and an IME program, wherein said dictionary data comprise of specific symbols, of indexical key symbols or combinational key symbols including them, which are assigned to those symbol in comply with condition that the geometrical forms of said indexical key is identical to that of designated specific symbol or a constituent part of it; said indexical keys are of the symbolic key of the United States standard keyboard.

4. The IME of claim 3, wherein said IME program retrieves from its dictionary data, and the interface of the IME displays these specific symbols designated by the input directives for user option when receiving a user's directives.

5. The IME of claim 3, wherein said key in combination including indexical one is “ALT+indexical keys”.

6. the IME for inputting specific symbols as claimed in claim 3, wherein said IME operational interface comprise multiple options to specific symbols, which is used for user directly press indexical key for displaying and choosing desired specific symbols under such condition as combinational key symbols including indexical key symbols assigned to these specific symbols, the ime program automatically retrieves from dictionary data, and read out the specific symbols designated to combinational key symbols including indexical key for users option.
